(19) United States
(12) Patent Application Publication
(10) Pub. No.: US 2007/0037960 A1
(43) Pub. Date: Feb. 15, 2007

(54) COPOLYESTER STILBENE EMBOSSED FILM AND METHODS OF MAKING THE SAME

(75) Inventors: Nitin Vaish, Evansville, IN (US); Yu Hu, Victor, NY (US); Kevin Patrick Capaldo, Mount Vernon, IN (US); Chung Hei Yeung, Evansville, IN (US); Nitin Garg, Evansville, IN (US); Steven J. Montgomery, Evansville, IN (US); Ganesh Kannan, Evansville, IN (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/428,941

(22) Filed: Jul. 6, 2006

Related U.S. Application Data
(63) Continuation-in-part of application No. 11/204,277, filed on Aug. 15, 2005, now Pat. No. 7,105,627.

(51) Int. Cl. C08G 63/00

(52) U.S. Cl. 528/307

(57) ABSTRACT

Disclosed herein are copolyester embossed film and methods of making the same. In one embodiment, the film making process comprises forming a substrate film, wherein the substrate film comprises a copolyester stilbene polymer, embossing the substrate film to form an embossed film, and cross-linking the embossed film. In another embodiment, the process comprises forming a substrate film, embossing the substrate film to form an embossed film, and cross-linking the embossed film. The substrate film comprises a copolyester comprising repeating units derived from stilbene dicarboxylic acid, 1,4 cyclohexane dicarboxylic acid, and 1,4-cyclohexane dimethanol.

### CROSS REFERENCE TO RELATED APPLICATIONS

The present application is a continuation-in-part of U.S. patent application Ser. No. 11/204,277, filed on Aug. 15, 2005, which is hereby incorporated by reference in its entirety.

### BACKGROUND OF THE INVENTION

Embossed films have been employed in a wide range of applications. In one application, embossed films have been successfully employed as optical films. Embossed films utilized in optical applications are embossed with prismatic surface features that are capable of diffusing, directing, polarizing, and/or concentrating light. As a result, embossed optical films are generally employed in many illuminated display applications (e.g., televisions, monitors, cellular telephones, personal data assistants, personal gaming devices, traffic signals, advertising displays, lighting and so forth). Embossed films also find utility in other applications, such as disposable hygienic films, such as, diapers, incontinence products, sanitary products, wound care products, and so forth.

Embossed films can be formed using various methods. Generally, the embossed surface features are formed through contact with a master pattern that comprises a negative image of the surface that is desired. In one method, a polymer film can be heated to a temperature that is sufficient to flow the polymer into the pattern, which is referred to as “hot embossing”. To be more specific, during the hot embossing process a polymer film is heated and compressed against an embossing drum or belt that comprises a negative image of the desired pattern. The heated film contours or flows into the surface features of the master pattern.

Various polymers have been employed in forming embossed films, including polycarbonate and others. Many polymer systems are utilized for their inertness to various use conditions. The more reactive a polymer with its surroundings the less stable it is, thus becoming potentially less desirable for its intrinsic characteristics.

What are needed in the art are melt processible polymer systems additional embossing systems, and films made therefrom.

### SUMMARY OF THE INVENTION

Disclosed herein are copolyester stilbene embossed film and methods of making the same. In one embodiment, the film making process comprises forming a substrate film, wherein the substrate film comprises a copolyester stilbene polymer, embossing the substrate film to form an embossed film, and cross-linking the embossed film.

In another embodiment, the process comprises forming a substrate film, embossing the substrate film to form an embossed film, and cross-linking the embossed film. The substrate film comprises a copolyester comprising repeating units derived from stilbene dicarboxylic acid, 1,4 cyclohexane dicarboxylic acid, and 1,4-cyclohexane dimethanol.

The above described and other features are exemplified by the following figures and detailed description.

### DESCRIPTION OF THE DRAWINGS

FIG. 1 Plots Eta* (Viscosity) relative to Time at 250° C. of a copolyester containing 10 mole % 4,4′-stilbene dicarboxylic acid, 90 mole %, 1,4-cyclohexane dicarboxylic acid, and 100% 1,4-cyclohexane dimethanol.

FIG. 2 illustrates a side view of an exemplary embossing system.

FIG. 3 illustrates a partial and cross-sectional view of an exemplary embossed film.

### DETAILED DESCRIPTION OF THE INVENTION

A copolyester stilbene polymer can be formed from a first portion comprising an acid comnposition and a second portion comprising a diol composition. For example, the first portion can comprise stilbene dicarboxylic acids and cyclohexane dicarboxylic acids, and the second portion can comprise 1,4-cyclohexane dimethanols.

The stilbene dicarboxylic acids in the first portion can be trans 3,3′, trans 4,4′, or a combination comprising at least one of the foregoing stilbene dicarboxylic acids, or, more specifically, trans 4,4′ stilbene dicarboxylic acids.

Generally, the stilbene dicarboxylic acids in the first portion can be present in an amount of about 1 mole percent (mole %) to about 40 mole %, or, more specifically, about 5 mole % to about 30 mole %, based on the total moles of the first portion. The copolyester stilbene polymer can be characterized by its clarity, as well as increased heat performance due to the presence of the stilbene moiety. The larger the stilbene presence, the higher the temperature performance, for example, glass transition temperature (T_{g}) and heat distortion temperature (HDT).

The cyclohexane dicarboxylic acids in the first portion can be cis, trans, or a mixture of cis and trans 1,4-cyclohexane dicarboxylic acids, or, more specifically, a mixture of cis and trans cyclohexane dicarboxylic acids.

Generally, the 1,4-cyclohexane dicarboxylic acids in the first portion can be present in an amount of about 95 mole % to about 70 mole %, based on the total moles of the first portion.

Optionally, terephthalic acids, isophthalic acids, or a combination comprising at least one of the foregoing acids can be present in the first portion replacing some of the 1,4-cyclohexane dicarboxylic acids in the first portion. The terephthalic acids, isophthalic acids, or a combination comprising at least one of the foregoing acids can be present in an amount of up to about 40 mole %, or, more specifically, about 0.1% to about 40 mole %, based on the total moles of the first portion. Generally, no more than about 25 mole % of terephthalic acids, isophthalic acids, or a combination comprising at least one of the foregoing acids is used.

Optionally, other acids such as aromatic dicarboxylic acids containing 8-20 carbon atoms and aliphatic dicarboxylic acids containing 3-20 atoms can also be present in the first portion replacing some of the 1,4-cyclohexane dicarboxylic acids in the first portion. Examples of such acids include 4,4′-biphenyl dicarboxylic acids, maleic acids, adipic acids, suberic acids, and dodecane dicarboxylic acids. Generally, up to about 25 mole %, or, more specifically, about 0.1 mole % to about 25 mole %, of these acids, based on the total moles of the first portion, can be present. The quantities of these and other materials can be chosen to attain desired characteristics of clarity and heat of the copolyester stilbene polymer.

The second portion of the copolyester stilbene polymer can comprise cis or trans 1,4-cyclohexane dimethanols, or a combination comprising at least one of the foregoing 1,4-cyclohexane dimethanols. The 1,4-cyclohexane dimethanols can be present in the second portion in an amount of about 50 mole % to about 100 mole %, or, more specifically, greater than or equal to about 60 mole %, or, even more specifically, about 70 mole %, based on the total moles of the second portion.

Optionally, ethylene glycols, butylene glycols, or a combination comprising at least one of the foregoing glycols can be present in the second portion replacing some of the cyclohexane dimethanols. The glycols can be present in an amount of up to about 50 mole %, or, more specifically, about 0.1 mole % to about 40 mole %, or, even more specifically, about 0.1 mole % to about 30 mole %, based on the total moles of the second portion.

Optionally, other diols containing 2-16 carbon atoms can also be present in the second portion. Exemplary diols include 1,3-propanediols, neopentyl glycols, 1,5-pentanediols, 1,6-hexanediols, and p-xylene glycols, and combinations comprising at least one of the foregoing diols. The diols can be present in an amount of up to about 50 mole %, or, more specifically, about 0.1 mole % to about 40 mole %, or, even more specifically, about 0.1 mole % to about 30 mole %, based on the total moles of the second portion.

Branched conolyesters can be prepared bv the incorporation of a trifunctional or greater functionality polyester branching agent. Examples of such agents include trimellitic anhydrides, trimesic acids, pentaerythritols, trimethylolpropanes, and combinations comprising at least one of the foregoing branching agents. These branching agents can be present in an amount of up to about 4 mole %, or, more specifically, about 0.01 mole % to about 4 mole %, or, yet more specifically, about 0.01 mole % to about 2 mole %, based upon the total composition (e.g., total moles of both the first portion and the second portion).

The copolyester stilbene polymers can be prepared by polymerization of the dicarboxylic acid(s) and/or ester(s) having desired acid units including stilbenes, in combination with desired diol(s). Various polyester polymerization conditions can be employed, and various synthetic pathways well known in the art can be used.

The copolyester polymers can be further crosslinked by exposure of the polyesters to radiation, especially ultraviolet radiation, generally at about 300 nanometers (nm) to about 400 nm, more specifically, about 365 nm. Temperature is not unduly significant and crosslinking reactions can occur at room temperature or at temperatures below the T_{g} of the polymer. Exposure to sunlight for a period of time is also effective in crosslinking the copolyester polymers.

Miscible blends of copolyester stilbene polymers with other polymers can be accomplished. Exemplary miscible blends can include poly(1,4-cyclohexylenedimethylene 1,4-cyclohexanedicarboxylate) (PCCD), as the other polymer (e.g., blended with the copolyester stilbene discussed above). These blends can similarly be irradiated as previously described to crosslink to a desired degree.

Suitable polymers that can be used for obtaining miscible blends include polycarbonates (e.g., polycarbonate monomers, copolyester carbonates, silicone containing polycarbonate copolymers, and so forth), polyesters, and combinations comprising at least one of the foregoing. Exemplary aromatic polycarbonates include bisphenol-A (BPA) polycarbonate as well as polycarbonates of other diphenols. Exemplary copolyester carbonates include copolymers of 1,3-resorcinol, isophthalic acid/terephthalic acid, and BPA-polycarbonate such as those referenced in U.S. Pat. No. 6,559,270 B1. Exemplary silicone containing polycarbonate copolymers include those found in U.S. Pat. No. 5,448,086 and U.S. Pat. No. 6,657,018.

The film and polymer are further illustrated by the following non-limiting examples with regard to copolyesters, embossed films, and/or embossing processes.

### EXAMPLE 1

This example illustrates the synthesis of a polymer comprising 90 mole % 1,4-cyclohexane dicarboxylic acid units, 10 mole % trans-4,4′-stilbene dicarboxylic acid units, and 100 mol % of 1,4-cyclohexane dimethanol.

A mixture of 100 g (0.50 mol) of 1,4-dimethylcyclohexane dicarboxylate, 16.44 grams (g) (0.05 moles) of dimethyl trans-4,4′-stilbene dicarboxylate, and 79.79 g (0.55 moles) 1,4-cyclohexane dimethanol, and 0.23 g of titanium tetraisopropoxide was placed in a 500 mL flask equipped with a nitrogen inlet, metal paddle stirrer, and short distillation column. The flask was heated gradually to 250° C. over a period of around 30 minutes. Once the overhead distillation slows, vacuum of 0.5 torr was applied gradually to the reaction. Full vacuum was maintained for around 20 minutes. A high melt viscosity clear polymer with an intrinsic viscosity (I.V.) of 0.83 deciliters per gram (dL/g) was obtained, as measured in a phenol/1,1,2,2-tetrachloroethane 60/40 (wt./wt.) at 25° C.

### EXAMPLE 2

This example illustrates the synthesis of a polymer comprising 80 mole % cyclohexane dicarboxylic acid units, 20 mole % trans-4,4′-stilbene dicarboxylic acid units, and 100 mole % of cyclohexane dimethanol.

A mixture of 17.2 lbs. (39.0 mol) of 1,4-dimethylcyclohexane dicarboxylate, 6.4 pounds (lbs.) (9.7 mol) of dimethyl trans-4,4′-stilbene dicarboxylate, 5.4 lbs. (48.5 mol) 1,4-cyclohexane dimethanol, and 14 g of titanium tetraisopropoxide was placed in a 15 gallon reactor equipped with a nitrogen inlet, helical stirrers, and short distillation column. The reactor was heated gradually to 250° C. over a period of around 1 hour. Once the overhead distillation slows, vacuum pf 1.5 torr was applied gradually to the reaction. Full vacuum was maintained for around 30 minutes. A high melt viscosity clear polymer with an I.V. of 0.88 dL/g was obtained.

A series of copolyesters was synthesized with varying composition. The glass transition temperature (T_{g}) data is presented in Table 1, as measured by DSC. As can be seen in the table, heat performance of the base resin increased with increased stilbene monomer incorporation.

TABLE 1

| Reaction | SB¹ | DMCD² | CHDM³ | T_{g} | IV⁴ |
|---|---|---|---|---|---|
| Number | (mole %) | (mole %) | (mole %) | (° C.) | (dL/g) |
| 1 | 0 | 100 | 100 | 71 | 0.84 |
| 2 | 2 | 98 | 100 | 74 | 0.85 |
| 3 | 5 | 95 | 100 | 77 | 0.82 |
| 4 | 10 | 90 | 100 | 83 | 0.83 |
| 5 | 20 | 80 | 100 | 93 | 0.88 |

¹SB refers to the 4,4′-stilbene dicarboxylic acid
²DMCD is dimethyl 1,4-cyclohexanedicarboxylate (98% trans)
³CHDM is 1,4 cyclohexane dimethanol (70% trans)
⁴IV is measured in a phenol/1,1,2,2-tetrachloroethane 60/40 (wt./wt.) at 25° C.

Upon exposure to ultraviolet (UV) radiation of about 365 nm, crosslinking occurs in the above copolyesters synthesized with stilbene dicarboxylate monomer. Resins were exposed to UV light at room temperature for varying lengths of time. In thin films, gel contents of 100% were measured in dichloromethane. Similar results are also obtained by exposing parts made from these resins to sunlight.

Completely miscible blends were made by melt mixing polycarbonate/poly(diorganosiloxane) copolymer with copolyester stilbene, copolyester stilbene with polycarbonate, and copolyester stilbene with copolymers of 1,3-resorcinol and polycarbonate. These blends were proven to be miscible throughout the entire composition range by the appearance of only one glass transition temperature upon the seecond heating on DSC (differential scanning calorimetry).

In Table 2 an example of blend data before and after UV radiation is described for the blends of the copolyester of Example 1 with BPA Polycarbonate. Upon exposure to UV radiation, an increase in Tg resulted in the copolyester as well as the blends with polycarbonate due to the presence of the copolyester as shown by the Tg of the neat polycarbonate which remained unchanged.

TABLE 2

| | SB¹ | PC² | | UV Tg | □Tg |
|---|---|---|---|---|---|
| No. | (wt %) | (wt %) | Tg (° C.) | (° C.) | (° C.) |
| 1 | 100 | 0 | 78.7 | 82 | 3.3 |
| 2 | 80 | 20 | 89.4 | 92 | 2.6 |
| 3 | 60 | 40 | 102.4 | 104 | 1.6 |
| 4 | 0 | 100 | 152.7 | 152.6 | −0.1 |

¹SB is the composition set forth as the copolyester in Example 1
²PC is BPA polycarbonate
³UV Tg is the Tg after UV irradiation

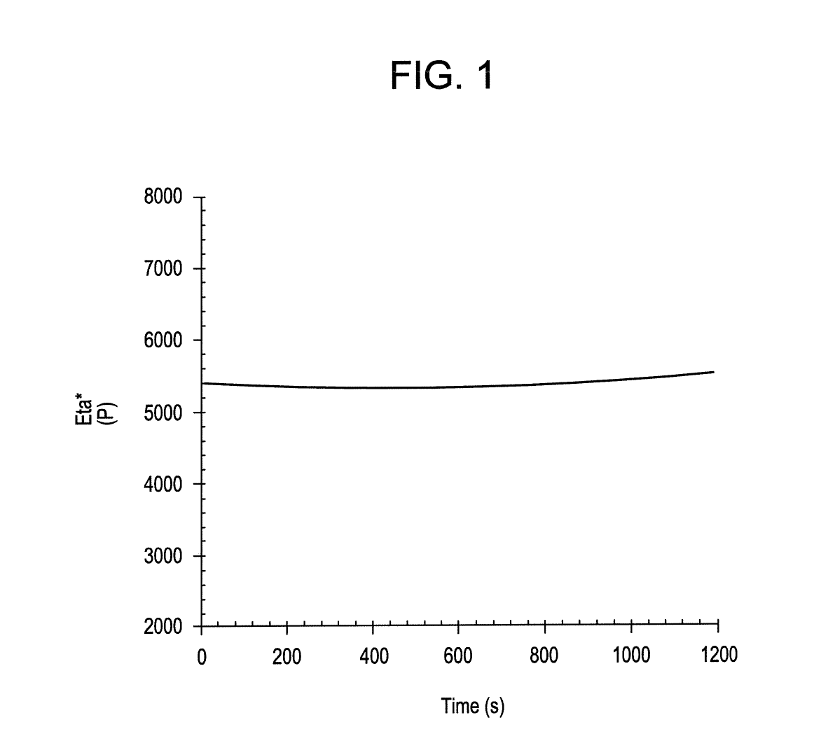

Refer now to FIG. 1 which measures Eta* (viscosity) relative to time at 250° C. The crosslinkable copolyester material is highly thermally stable. As can bee seen from the graph, the Eta* was fairly constant, fluctuating a mere 400 over a period of 1,200 seconds. The results were obtained using an ARES strain controlled parallel plate rheometer, under nitrogen, plate diameter of 25 millimeters (mm) and a gap of 1.0 mm.

These examples illustrate that melt stable polymers and blends can be prepared such that useful parts and applications can be made. The resulting articles can be photo-crosslinked to exhibit improved properties such as heat and dimensional stability.

Table 3 set forth the flexural strength, Notched Izod (in foot pounds force (ft-lbf), and heat distortion temperature (HDT) for two copolymer compositions. The same mechanical properties were also measured for the resins after crosslinking by UV radiation to a gel content of around 50%. The flexural strength of the resins increased with crosslinking, while the break when measured by Notched Izod remained ductile. It is also important to note the HDT measured at 66 pounds per square inch (psi) also increased for each material upon crosslinking.

TABLE 3

| | Composition | | | | | Notched | |
|---|---|---|---|---|---|---|---|
| | SB¹ | DMCD² | CHDM³ | Gel | Flexural | Izod | HDT at |
| | (mole | (mole | (mole | Content⁴ | Strength | (RT) | 66 psi |
| No. | %) | %) | %) | (%) | (psi) | (ft-lbf) | (° C.) |
| 1 | 10 | 90 | 100 | 0 | 7370 | 17.9 | 64.6 |
| 2 | 10 | 90 | 100 | 50 | 7970 | 18.3 | 69.8 |
| 3 | 20 | 80 | 100 | 0 | 7710 | 12.4 | 69.5 |
| 4 | 20 | 80 | 100 | 50 | 8870 | 11.1 | 77.2 |

¹SB refers to the 4,4′-stilbenedicarboxylic acid
²DMCD is dimethyl 1,4-cyclohexanedicarboxylate (98% trans)
³CHDM is 1,4 cyclohexane dimethanol (70% tans)
⁴Gel Content calculated by insoluble resin in dichloromethane (determined gravimetrically).

Articles can be prepared from the copolyester and combinations comprising the copolyester. These articles can be prepared using various techniques such as injection molding, film and sheet extrusion, film and sheet coextrusion, blow molding, coating, powder coating and the like. Crosslinking of the copolyester can be carried out on the articles after formation. For example, in one embodiment, an embossed film can be produced from a substrate comprising the copolyester (e.g., a copolyester stilbene polymer) via an embossing apparatus. After the embossed film has been formed it can be routed through a cross-linking section where the film can be cross-linked, e.g., via irradiation with UV light.

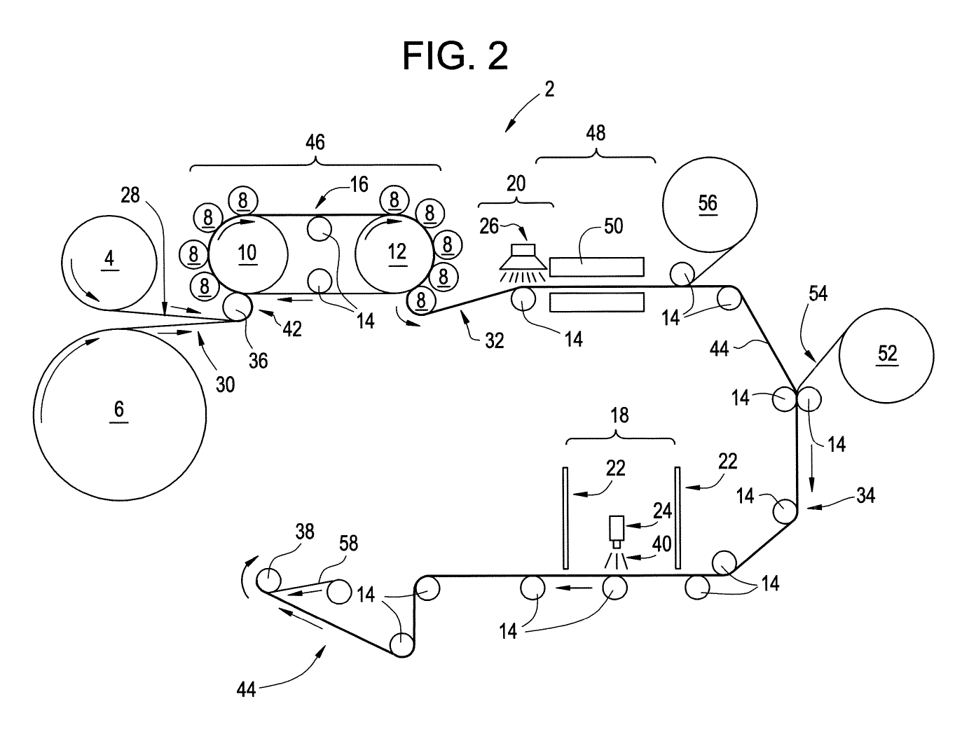

Referring now to FIG. 2, an exemplary embossing system 2 is illustrated. The embossing system 2 comprises an embossing apparatus 46 capable of producing an embossed film (i.e., an embossed substrate film) 32 comprising the copolyester described above. Once the substrate film has been embossed, it can be cross-linked as desired.

The embossing system 2 may optionally also comprise secondary operations, namely, a cross-linking and/or annealing process (e.g., via cross-linking and/or annealing zone 48 ), and a coating process (e.g., via coating zone 20 (e.g., an on-line and/or off-line coating zone(s))). The cross-linking zone 48 is capable of cross-linking the copolyester, e.g., via UV irradiation.

The embossing system 2 can be configured to comprise any configuration of secondary processes, as desirable. Secondary operations include any process performed on and/or to the film subsequent to embossing, e.g., that modifies, adds value to, and/or changes the properties of an embossed film 32, as well as combinations comprising at least one of the foregoing. For example, secondary operations comprise, curing, coating operations, annealing processes, printing, trimming, further assembly, laminating, forming, as well as combinations comprising at least one of the foregoing.

The embossing apparatus 46 comprises an embossing belt 16 that travels about a heating roller 10 and a chill roll 12, as shown by the directional arrows. The embossing belt 16, which comprises a negative of a desired imprint, is supported between the heating roller 10 and the chill roll 12 by two support rollers 14. A support film roll 4 supplies a support film 28, and a substrate film roll 6 supplies a substrate film 30 to a lead compression roller 36, where the support film 28 and the substrate film 30 (hereinafter referred to as “films”) can be layered to form a laminate 42. In an alternative embodiment, the embossing apparatus 46 can comprise an extruder that feeds a molten polymer to a nip between calendering rolls (not shown).

The substrate film 30 comprises polymers that demonstrate desirable optical properties. For example, transparent polymers exhibiting a transmission (Tr) of greater than about 80%, or more specifically greater than about 90%, (as measured by ASTM D1746-03) are desirable. One such polymer exhibiting these properties is polycarbonate (e.g., Lexan, manufactured by General Electric Company, GE Plastics, Pittsfield, Mass.). Another polymer exhibiting such properties is copolyester stilbene. The thickness of the substrate layer 30 can comprise a thickness of about 2 mil (51 micrometers (μm)) to about 60 mil (1,524 μm), however it is apparent that the specific thickness is a function of the materials employed, the embossing process, end-users requirements, and other variables.

The optional support film 28 can support the substrate film 30 as it is heated. In addition, the support film 28 can protect the surface finish of the substrate film 30 during embossing and prevent the substrate film 30 from adhering to the compression rollers 8. The support film 28 can comprise polymeric materials that comprise a glass transition temperature (Tg) and/or melt temperature (Tm) that is higher than the substrate film 30, so that the support film 28 can support the substrate film 30 as it is preheated and prevent the substrate film 30 from deforming. One such polymer that has exhibited success in this application is polyethylene terephthalate (e.g., Mylar, manufactured by E.I. du Pont de Nemours and Company, Wilmington, DEL.). A polyethylene terephthalate does not adhere to many substrate films 30, which allows for easy removal therefrom. Support film 28 can comprise a sufficient thickness to attain the desired structural properties, e.g., it can have a thickness of about 2 mil (51 μm) to about 60 mil (1,524 μm), however it is apparent that the specific thickness is a function of the materials employed, the embossing process, end-users requirements, as well as other variables.

The laminate 42 (e.g., the term “laminate” is used to denote a layered structure and does not imply a bond therebetween) travels around a lead compression roller 36 to contact the embossing belt 16. Upon contact with the embossing belt 16, the laminate 42 and the embossing belt 16 are compressed between the lead compression roller 36 and the heating roller 10 (e.g., this can be referred to as a “nip” or a “nip section”). As the laminate 42 and the embossing belt 16 travel through an annular array of nip sections via compression rollers 8, the heating roller 10 heats the embossing belt 16 and the laminate 42. The laminate 42 is heated to a temperature that is sufficient to allow the substrate film 30 to flow into surface features that are disposed on the surface of the embossing belt 16 (not shown), forming an embossed film 32.

The embossed film 32 then travels on the embossing belt 16 under a series of compression rollers 8 disposed in an annular array about the chill roll 12, which cools the embossed film 32 so that the geometry of the surface features in the embossing belt 16 are retained on a surface of the embossed film 32. The embossed film 32 is then stripped from the embossing belt 16.

The embossing belt 16 can comprise an endless belt formed from a metal (e.g., nickel), metal alloy (e.g., martensitic, ferritic, and austenitic stainless materials, and/or nickel-titanium alloy), polymer (e.g., EPDM, silicone, and so forth), as well as combinations comprising at least one of the foregoing. For example a nickel embossing belt 16 comprising a thickness of about 0.010 inches (254 μm) to about 0.200 inches (5,080 μm) can be employed. Furthermore, the embossing belt 16 can be configured to comprise any configuration of surface features (e.g., imprints) that produce a desirable embossed film 32. The surface features can be formed in the embossing belt 16 utilizing various method, such as, etching, electrical discharge machining, stamping, milling, and so forth.

The rollers (i.e., lead compression roller 36, heating roller 10, compression rollers 8, support rollers 14, take-up roller 38, masking film roll 52, support film take-up roll 56, and chill roll 12) can be disposed in a relationship that is about parallel with one another, which promotes uniform thickness and uniform residual stresses across the width of the embossed film 32. Furthermore, the rollers can be configured in any configuration that provides ample heating, cooling, compression, and support for the embossed film 32. The rollers can be manufactured from metals (e.g., copper, aluminum, and/or iron), metal alloys (e.g., martensitic, ferritic, and/or austenitic stainless materials), polymers (e.g., ethylene propylene diamine monomer based rubber (EPDM) or silicone), as well as configurations comprising at least one of the following. For example, in one embodiment, a roller can comprise 316 stainless steel and a chromed external surface coating. The outer surface of the rollers generally comprises a smooth, polished surface, however, can comprise a texture, pattern, and the like. The rollers can also comprise thermal elements, flow paths and/or conduits, and so forth, to enable control of the roller's temperature. For example, the rollers 10, 12, can be configured to comprise an internal geometry comprising a flow path (e.g., spiral) through which a thermal transfer media (e.g., oil, ethylene glycol, and/or water) can flow. The flow path can comprise an inlet disposed on one end of the roller's axel and an outlet disposed on the other end of the roller's axel. In another example, the heating roller 10 can comprise a spirally wrapped resistive heating element capable of connecting to an electrical source and heating the roller.

During operation, the compression rollers 8 can exert a force of about 10 to about 100 pounds per square inch, (psi) (about 0.703 to about 7.031 kilograms per square centimeter, K/cm²) on the film, or more specifically about 25 to about 90 psi (about 1.76 to about 6.33 K/cm²), or even more specifically about 50 to about 80 psi (about 3.52 to about 5.62 K/cm²). The laminating roller can exert about 0.1 to about 10 psi (about 0.007 to about 0.070 K/cm²) on the film, or more specifically about 0.5 to about 5 psi (about 0.035 to about 0.352 K/cm²), or even more specifically about 1 to about 2.5 psi (about 0.070 to about 0.176 K/cm²).

The embossed film 32 can be embossed with surface features comprising any shape that can be embossed into the film. Possible surface features include light-reflecting elements such as cube-corners (e.g., triangular pyramid), trihedral, hemispheres, prisms, ellipses, tetragonal, grooves, channels, microlenses, and others, as well as combinations comprising at least one of the foregoing. The specific configuration of the surface features (e.g., height, shape, and/or width) will influence the characteristics of the embossed film. For example, in optical films, influenceable characteristics include, light incidence angles, prismatic effect of the feature, reflections of light within the feature, total light transmission, and so forth, as well as combinations comprising at least one of the foregoing.

The embossing apparatus 46 is capable of producing embossed films 32 comprising macroscale, microscale and/or nanoscale surface features. Macroscale surface features have a size of approximately 1 millimeter (mm) to about 1 meter (m) or the entire size of the part being formed; i.e. of a size scale easily discerned by the human eye. Microscale surface features have a size of less than or equal to about 1 mm, or, more specifically, greater than 100 nanometers (nm) to about 1 mm. Nanoscale surface features have a size of less than or equal to about 500 nm, or, more specifically, less than or equal to about 100 nm, or, even more specifically, less than or equal to about 20 nm, and yet more specifically, about 0.5 nm to 10 nm.

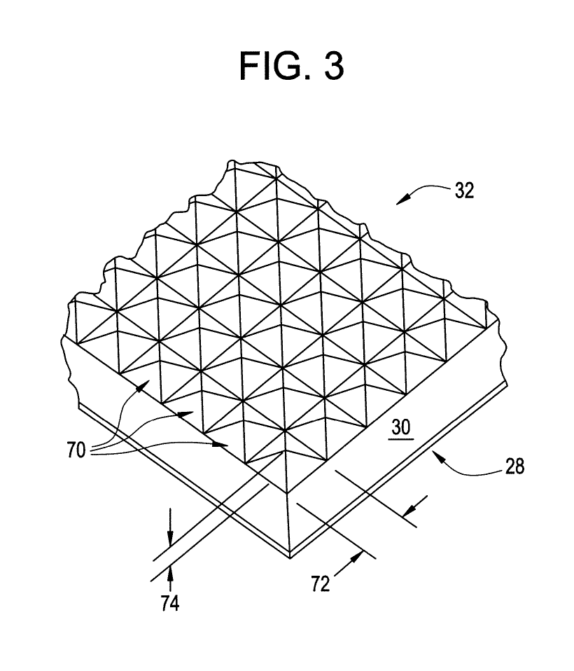

Referring also to FIG. 3, the embossed film 32 comprises a substrate film 30 comprising micro-scale surface features 70 (e.g., with nanoscale resolution) that have been formed thereon by embossing apparatus 46. The support film 28 is disposed on the substrate film 30 opposite the micro-scale surface features. The micro-scale surface features 70 comprise pyramidal geometries, having a base width 72 and a height 74. For example, the base width 72 is about 30 micrometers, μm (about 0.0011 in) and the height 74 is about 20 μm (about 0.0008 in). Some possible geometries include retroreflective elements such as cube-corners (e.g., triangular pyramid), trihedral, hemispheres, prisms, ellipses, tetragonal, grooves, channels, and others, as well as combinations comprising at least one of the foregoing.

Once the embossing apparatus 46 has formed the embossed film 32, it is conveyed on support rollers 14 through the cross-linking zone 20. The cross-linking (e.g., curing) zone 20 can comprise any energy source 26 (e.g., thermal, and/or irradiative, and so forth) that is capable of cross-linking the embossed film 32. In one embodiment, energy source 26 can comprise a light, wherein any light capable of producing radiation at a wavelength that initiates cross-linking of the copolyester can be employed. The light can comprise radiation such as UVA, UVB, UVC, UVV, and so forth. Exemplary configurations include ultraviolet lamps comprising xenon, metallic halide lamps, metallic arc lamps, low high-pressure mercury vapor discharge lamps, high-pressure mercury vapor discharge lamps, sunlight, and so forth, as well as combinations comprising at least one of the foregoing lights. For example, a copolyester stilbene embossed film many be cured with UV radiation at about 360 nm to about 370 nm.

An exposure dose of equal to or greater than about 0.100 joules/cm² can be adequate to cross-link the embossed film 32, however equal to or greater than about 0.300 joules/cm², or even equal to or greater than about 0.500 joules/cm² can be employed. A desired degree of cross-linking will depend upon the particular application for the embossed film 32. The cross-linking zone 20 can be configured to comprise a length and any number of energy sources 26 that are sufficient to attain the desired cross-linking of the copolyester.

Once the embossed film 32 has been cross-linked, it can optionally be additionally processed or it can be removed from the embossing system, for example via take-up roller 38. If additional processing is desired, the cross-linked film can be conveyed on support rollers 14 through the annealing zone 48. During the annealing process, the embossed film 32 is heated to a temperature that is sufficient to attain the desired residual stress level within the film. However, to avoid deformation of the film and/or surface features, the temperature employed is less than the glass transition temperature of the film. For example, embossed films comprising greater than or equal to about 93 wt.% polycarbonate (e.g., having a Tg of about 320° F.) can be heated to a temperature of about 270° F. (about 132° C.), wherein the weight percent is based on the total weight of the film.

After the embossed film has been annealed in the annealing zone 48, the optional support film 28 can be removed from the embossed film 32 and spooled on a support film take-up roll 56. Thereafter, a masking film 54 supplied by the masking film roll 52, can be laminated onto a surface of the embossed film 32 opposite the embossed surface.

If desired, a coating can optionally be applied (e.g., sprayed) onto the embossed film 32. The coating zone 18 can be configured in any manner to coat an embossed film 32, e.g., while following the contours of the embossed film. The coating zone can be located before or after the annealing zone 48. In the embodiment illustrated, the coating zone 18 comprises nozzles 24 that are configured to distribute (e.g., spray) a layer of the coating 40 onto the embossed side of masked embossed film 34. The nozzles 24 can comprise any design that is capable of distributing the coating 40 onto the film, such as, high pressure nozzles that can distribute droplets of coating onto the masked embossed film 34 wherein the droplets have a diameter of less than or equal to about 500 μm (about 19.7 mils), or more specifically, less than or equal to about 300 μm (about 11.8 mils) or even more specifically, less than or equal to about 100 μm (about 3.94 mils) in diameter.

Once the embossed film 32 has been cross-linked and optionally annealed and/or coated (and/or otherwise processed), the cross-linked film 44 is spooled on a take-up roll 38. A protective masking film 58 (e.g., a pressure sensitive masking film) can be applied on the embossed side of the film 44 before the product roll is wound on the take-up roll 38. The protective masking film 58 can have a sufficient thickness to protect the embossed features from damage, e.g., can have a thickness of about 1 mil (25.4 micrometers (μm)) to about 3 mils (76.2 μm).

The embossed copolyester film can attain desired structural integrity and properties without the use of a coating. The surface features can be embossed directly into the substrate. In other words, a single, unitary copolyester stilbene film can receive the surface features directly into the surface thereof. No embossed coating is needed to attain the desired surface features.

The terms “a” and “an” do not denote a limitation of quantity, but rather, denote the presence of at least one of the referenced item. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Furthermore, as used herein, “combination” is inclusive of blends, mixtures, alloys, reaction products, and the like. Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A film making process, comprising:
forming a substrate film, wherein the substrate film comprises a copolyester stilbene polymer;
embossing the substrate film to form an embossed film comprising imprints in the substrate film; and,
cross-linking the embossed film.

2. The process of claim 1, wherein cross-linking further comprises irradiating the embossed film.

3. The process of claim 1, wherein the substrate film is not cross-linked.

4. The process of claim 1, wherein the substrate film is partially cross-linked.

5. The process of claim 1, wherein the substrate film comprises a blend of the copolyester and polymer selected from the group consisting of polycarbonate, polyester, and combinations comprising at least one of the foregoing polymers.

6. The process of claim 1, wherein embossing the substrate film further comprises physically contacting a surface of the substrate film with a negative of the imprints.

7. A film making process, comprising:
forming a substrate film, wherein the substrate film comprises a copolyester, wherein the copolyester comprises repeating units derived from
a first portion, based upon 100 moles, comprising
about 1 mole % to about 40 mole % of stilbene dicarboxylic acid selected from the group consisting of trans 3,3′ stilbene dicarboxylic acid, trans 4,4′ stilbene dicarboxylic acid, and a combination comprising at least one of the foregoing stilbene acids, and
about 60 mole % to about 99 mole % of 1,4 cyclohexane dicarboxylic acid selected from the group consisting of cis, trans cyclohexane dicarboxylic acid, and a combination comprising at least one of the foregoing 1,4 cyclohexane dicarboxylic acids; and
a second portion, based upon 100 moles, comprising
about 50 mole % to about 100 mole % of 1,4-cyclohexane dimethanol selected from the group consisting of cis, trans cyclohexane dimethanol, and a combination comprising at least one of the foregoing 1,4-cyclohexane dimethanols; and
embossing the substrate film to form an embossed film; and,
cross-linking the embossed film.

8. The process of claim 7, wherein the second portion further comprises:
0.1 mole % to about 50 mole % glycol; and
less than or equal to about 2 mole % of a branching agent.

9. The process of claim 8, wherein the glycol is selected from the group consisting of ethylene glycol, butylene glycol, and a combination comprising at least one of the foregoing glycols.

10. The process of claim 9, wherein the second portion comprises about 0.1 mole % to about 30 mole % glycol.

11. The process of claim 7, wherein the first nortin compnrises about 5 mole % to about 30 mole % trans 4-4′ stilbene dicarboxylic acid.

12. The process of claim 7, wherein the first portion comprises about 0.1 mole % to about 25 mole % phthalic acid.

13. The process of claim 7, wherein cross-linking further comprises irradiating the embossed film.

14. The process of claim 7, wherein the substrate film is not cross-linked.

15. The process of claim 7, wherein the substrate film is partially cross-linked.

16. The process of claim 7, wherein the substrate film further comprises at least two chains of the copolyester where there is a covalent bond between an aliphatic unsaturation of a stilbene residue in one chain and an aliphatic unsaturation of a stilbene residue in a second chain.

17. The process of claim 7, wherein the substrate film comprises a blend of the copolyester and polymer selected from the group consisting of polycarbonate, polyester, and combinations comprising at least one of the foregoing polymers.

18. The process of claim 7, wherein the first portion further comprises about 0.1 mole % to about 40 mole % phthalic acid selected from the group consisting of terephthalic acid, isophthalic acid, and a combination comprising at least one of the foregoing phthalic acid.

19. An embossed film formed from the process of claim 1.

20. An embossed film formed from the process of claim 7.

21. A film making process, comprising:
forming a substrate film, wherein the substrate film comprises a copolyester, wherein the copolyester comprises repeating units derived from
a first portion comprising
about 1 mole % 40 mole % of stilbene dicarboxylic acid selected from the group consisting of trans 3,3′ stilbene dicarboxylic acid, trans 4,4′ stilbene dicarboxylic acid, and a combination comprising at least one of the foregoing stilbene acids, and
about 60 mole % to about 99 mole % 1,4 cyclohexane dicarboxylic acid selected from the group consisting of cis, trans, and a combination comprising at least one of the foregoing 1,4 cyclohexane dicarboxylic acid; and
a second portion comprising
about 50 mole % to about 100 mole % 1,4-cyclohexane dimethanol selected from the group consisting of cis, trans, and a combination comprising at least one of the foregoing 1,4-cyclohexane dimethanols;
embossing the substrate film to form an embossed film; and
cross-linking the embossed film.
